(19) United States
(12) Patent Application Publication
(10) Pub. No.: US 2023/0294027 A1
(43) Pub. Date: Sep. 21, 2023

(54) FILTER TRACK SYSTEM FOR HVAC SYSTEM

(71) Applicant: Johnson Controls Tyco IP Holdings LLP, Milwaukee, WI (US)

(72) Inventors: Harshvardhan Goverdhan Jadhav, Pune (IN); Atishkumar Shamrao Dhage, Pune (IN); Kaleemullah Khan Mohammed, Norman, OK (US)

(21) Appl. No.: 17/696,722

(22) Filed: Mar. 16, 2022

(51) Int. Cl. B01D 46/00; F24F 13/28

(52) U.S. Cl. CPC B01D 46/0009; F24F 13/28; B01D 2279/50; B01D 2265/025

(57) ABSTRACT

A filter track system of a heating, ventilation, and/or air conditioning (HVAC) system includes a filter track having a base segment, a first bracket extending crosswise to the base segment, a second bracket extending crosswise to the base segment, and a tab formed in the base segment. The filter track is configured to capture a first filter via the first bracket and the second bracket in a first configuration of the filter track, and the filter track is configured to capture a second filter via the tab and the first bracket in a second configuration of the filter track.

### BACKGROUND

This section is intended to introduce the reader to various aspects of art that may be related to various aspects of the present disclosure and are described below. This discussion is believed to be helpful in providing the reader with background information to facilitate a better understanding of the various aspects of the present disclosure. Accordingly, it should be noted that these statements are to be read in this light, and not as admissions of prior art.

Heating, ventilation, and/or air conditioning (HVAC) systems are utilized in residential, commercial, and industrial environments to control environmental properties, such as temperature and humidity, for occupants of the respective environments. An HVAC system may control the environmental properties through control of a supply air flow delivered to the environment. For example, the HVAC system may place the supply air flow in a heat exchange relationship with a refrigerant of a vapor compression circuit to condition the supply air flow. In some embodiments, the HVAC system may include a filter configured to remove particles within an air flow, such as the supply air flow, by entrapping the particles and enable flow of the air through the filter. The HVAC system may, for instance, include a support structure configured to receive the filter and position the filter in a particular location within the HVAC system. Unfortunately, in existing HVAC systems, the support structure may be specifically manufactured to accommodate a filter having a particular dimension or a particular size. As such, the support structure may not be configured for use with different types of filters in the HVAC system.

### SUMMARY

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a filter track system of a heating, ventilation, and/or air conditioning (HVAC) system includes a filter track having a base segment, a first bracket extending crosswise to the base segment, a second bracket extending crosswise to the base segment, and a tab formed in the base segment. The filter track is configured to capture a first filter via the first bracket and the second bracket in a first configuration of the filter track, and the filter track is configured to capture a second filter via the tab and the first bracket in a second configuration of the filter track.

In one embodiment, a filter system of a heating, ventilation, and/or air conditioning (HVAC) system includes a filter track having a base segment, a first bracket and a second bracket extending from opposite sides of the base segment, and a tab integral with the base segment and formed between the first bracket and the second bracket. The tab is configured to extend along the base segment in a first configuration of the filter track, and the tab is configured to extend crosswise to the base segment in a second configuration of the filter track. The filter track is configured to capture a first filter in the first configuration of the filter system, and the filter track is configured to capture a second filter in the second configuration of the filter system

In one embodiment, a filter system of a heating, ventilation, and/or air conditioning (HVAC) system includes a filter track with a base segment, a first bracket extending crosswise to the base segment, and a second bracket extending crosswise to the base segment. The base segment includes a plurality of openings formed therethrough to form a tab in the base segment between the first bracket and the second bracket, and the tab is adjustable to selectively retain a first filter and a second filter within the filter track. The tab and the base segment are configured to engage with a common side of the first filter to retain the first filter within the filter track, and the tab and the first bracket are configured to engage with opposite sides of the second filter to retain the second filter within the filter track

### BRIEF DESCRIPTION OF THE DRAWINGS

Various aspects of this disclosure may be better understood upon reading the following detailed description and upon reference to the drawings in which:

FIG. 1 is a perspective view of an embodiment of a heating, ventilation, and/or air conditioning (HVAC) system for environmental management that may employ one or more HVAC units, in accordance with an aspect of the present disclosure;

FIG. 2 is a perspective view of an embodiment of a packaged HVAC unit that may be used in the HVAC system of FIG. 1, in accordance with an aspect of the present disclosure;

FIG. 3 is a cutaway perspective view of an embodiment of a residential, split HVAC system, in accordance with an aspect of the present disclosure;

FIG. 4 is a schematic of an embodiment of a vapor compression system that can be used in any of the systems of FIGS. 1-3, in accordance with an aspect of the present disclosure;

FIG. 5 is a front perspective view of an embodiment of a filter system of an HVAC system, illustrating filters supported by a filter track system, in accordance with an aspect of the present disclosure;

FIG. 6 is a partial perspective view of an embodiment of filter tracks of a filter track system of an HVAC system configured to accommodate filters having a greater thickness, in accordance with an aspect of the present disclosure;

FIG. 7 is a partial perspective view of an embodiment of filter tracks of a filter track system of an HVAC system configured to accommodate filters having a smaller thickness, in accordance with an aspect of the present disclosure;

FIG. 8 is a partial perspective view of an embodiment of a filter tracks of a filter track system of an HVAC system capturing a filter having a greater thickness, in accordance with an aspect of the present disclosure;

FIG. 9 is a partial perspective view of an embodiment of a filter tracks of a filter track system of an HVAC system capturing a filter having a smaller thickness, in accordance with an aspect of the present disclosure;

FIG. 10 is a partial top perspective view of an embodiment of a filter track of a filter track system of an HVAC system, in accordance with an aspect of the present disclosure;

FIG. 11 is a partial bottom perspective view of an embodiment of a filter track of a filter track system of an HVAC system, in accordance with an aspect of the present disclosure;

FIG. 12 is a side perspective view of an embodiment of a filter system of an HVAC system, in accordance with an aspect of the present disclosure; and

FIG. 13 is a front perspective view of an embodiment of a filter system of an HVAC system, in accordance with an aspect of the present disclosure.

### DETAILED DESCRIPTION

One or more specific embodiments will be described below. In an effort to provide a concise description of these embodiments, not all features of an actual implementation are described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features.

The present disclosure is directed to a heating, ventilation, and/or air conditioning (HVAC) system through which an air flow is directed. The HVAC system may circulate a refrigerant through a vapor compression system that is configured to condition a supply air flow that is provided to a conditioned space. For example, the vapor compression system may include a heat exchanger configured to circulate the refrigerant, and the supply air flow may be directed across the heat exchanger to exchange heat with the refrigerant and condition the supply air flow. The HVAC system may also include a filter configured to remove particles from the supply air flow. For example, the filter may entrap particles, such as dust, debris, impurities, and/or contaminants, within the supply air flow to block the particles from being directed to other components of the HVAC system and/or to the space serviced by the HVAC system. In this manner, the filter may maintain a desirable operation (e.g., efficiency) of the HVAC system and/or a quality of the air flow.

In some embodiments, the HVAC system may include a structural support system, such as a filter track system, configured to receive the filter and position the filter within the HVAC system. However, conventional structural supports may be configured to receive a particular embodiment or configuration of a filter, such as a filter having a particular dimension or size. In other words, traditional structural supports may not be able to receive various embodiments of filters. As such, the structural support may not enable implementation of different embodiments of filters in an HVAC system, thereby limiting design and/or operational flexibility of the HVAC system. Indeed, different structural supports (e.g., different embodiments of a structural supports) may be manufactured for use with different filter embodiments that may be incorporated in the HVAC system. However, design and manufacture of multiple structural supports specifically designed to receive a filter of a particular embodiment may increase costs associated with manufacture and/or assembly of the HVAC system.

Thus, it is presently recognized that a structural support system configured to accommodate and secure different embodiments of filters, such as filters having different dimensions, may increase flexibility of design and/or operation of an HVAC system. Accordingly, embodiments of the present disclosure are directed to a filter track system that is adjustable to receive and secure different filter embodiments. For example, the filter track system may include a filter track that is adjustable to capture filters having different dimensions, such as different thicknesses. The filter track may include a tab formed therein via cuts or openings formed in the filter track, and the tab may be adjusted to enable the filter track to capture a filter of a particular thickness. As an example, the filter track may include a base segment and brackets (e.g., lateral segments) extending crosswise to the base segment to form a C-shape or U-shape (e.g., cross-section of the filter track). The tab may be formed in the filter track between the brackets. As discussed further below, the tab may be oriented in a first configuration to extend along (e.g., align with) the base segment and enable the brackets to capture a filter having a greater thickness. Moreover, the tab may be transitioned (e.g., bent, folded, adjusted) to a second configuration to extend crosswise to the base segment to enable the tab and one of the brackets to capture a filter having a smaller thickness. The tab may be manually adjusted between the first configuration and the second configuration to enable receipt and capture of differently sized filters within the filter track. Thus, a single embodiment of the filter track system may be manufactured and utilized with differently sized filters (e.g., filter having different thicknesses) within the filter track system. In this way, costs and/or complexity associated with manufacture of different HVAC systems, such as HVAC systems having filters with different thicknesses, may be reduced. Additionally, the present techniques enable conversion of the filter track system between different configurations after installation of the HVAC system. Therefore, an installed HVAC system may utilize a first type (e.g., having a first thickness) of filter, and the filter track system may be adjusted to subsequently utilize a second type of filter (e.g., having a second thickness) with the HVAC system, as desired.

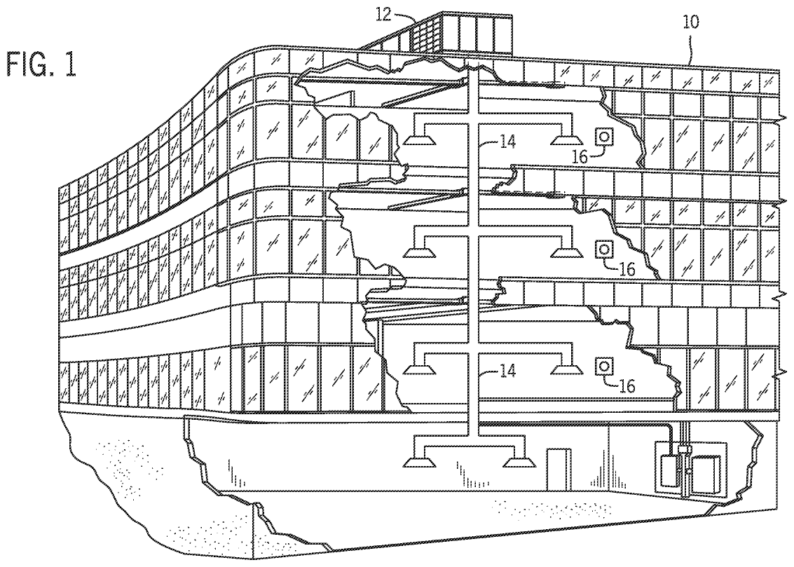

Turning now to the drawings, FIG. 1 illustrates an embodiment of a heating, ventilation, and/or air conditioning (HVAC) system for environmental management that may employ one or more HVAC units. As used herein, an HVAC system includes any number of components configured to enable regulation of parameters related to climate characteristics, such as temperature, humidity, air flow, pressure, air quality, and so forth. For example, an “HVAC system” as used herein is defined as conventionally understood and as further described herein. Components or parts of an “HVAC system” may include, but are not limited to, all, some of, or individual parts such as a heat exchanger, a heater, an air flow control device, such as a fan, a sensor configured to detect a climate characteristic or operating parameter, a filter, a control device configured to regulate operation of an HVAC system component, a component configured to enable regulation of climate characteristics, or a combination thereof. An “HVAC system” is a system configured to provide such functions as heating, cooling, ventilation, dehumidification, pressurization, refrigeration, filtration, or any combination thereof. The embodiments described herein may be utilized in a variety of applications to control climate characteristics, such as residential, commercial, industrial, transportation, or other applications where climate control is desired.

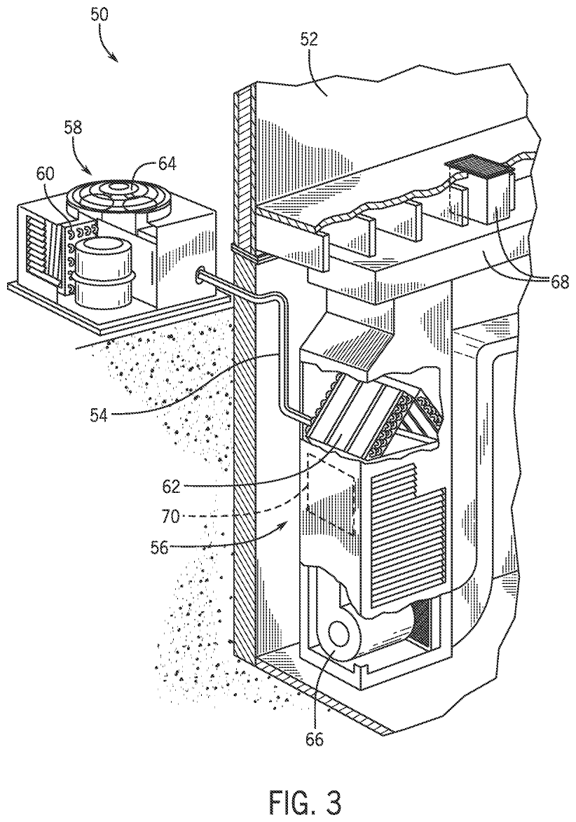

In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

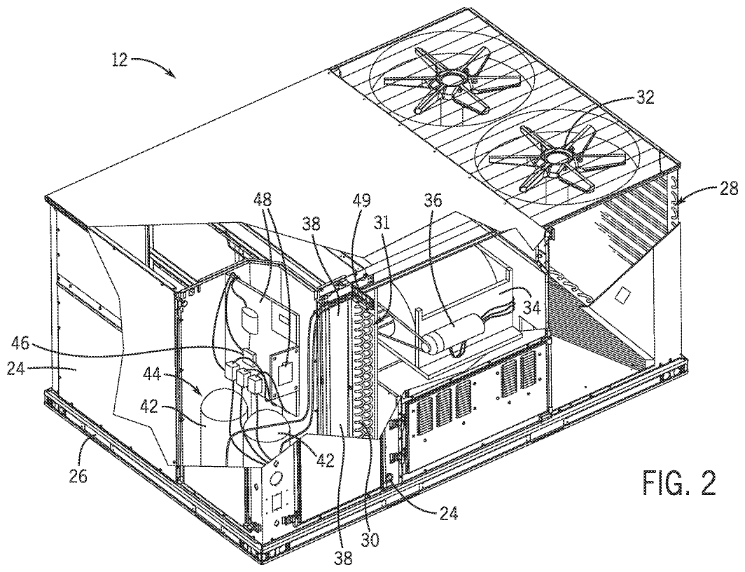

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit onto “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant, such as R-410A, through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the HVAC unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. Additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms. One or more of these components may be referred to herein separately or collectively as the control device 16. The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant, which may be expanded by an expansion device, and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat, or the set point plus a small amount, the residential heating and cooling system 50 may become operative to refrigerate additional air for circulation through the residence 52. When the temperature reaches the set point, or the set point minus a small amount, the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over the outdoor heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger, separate from heat exchanger 62, such that air directed by the blower 66 passes over the tubes or pipes and extracts heat from the combustion products. The heated air may then be routed from the furnace system 70 to the ductwork 68 for heating the residence 52.

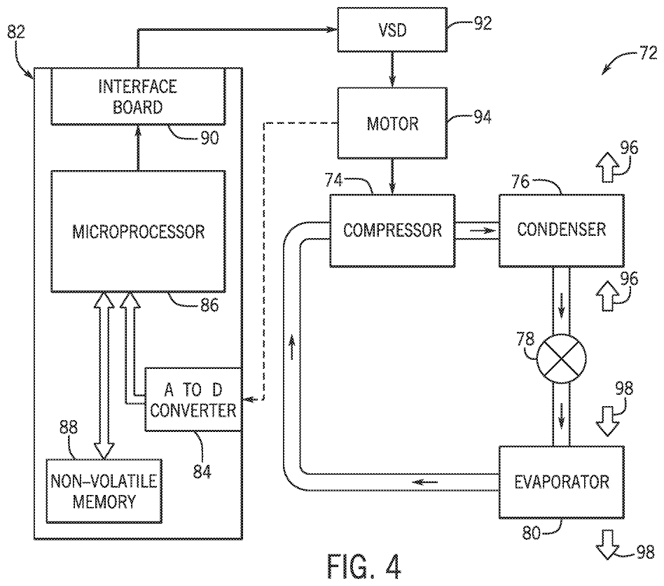

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

Any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

The present disclosure is directed to a filter track system of an HVAC system configured to capture filters having different thicknesses. For example, the filter track system may include a filter track that is configured to capture a first filter having a first thickness and is adjustable to capture a second filter having a second, different thickness. In some embodiments, the filter track may include a base segment, brackets extending from opposite sides of the base segment, and a tab formed in the base segment via cuts or openings formed through the base segment. The tab may be adjustable (e.g., manually adjustable), such as rotatable, bendable, or foldable, between different configurations to enable accommodation and retention of differently-sized filters. In a first configuration, the tab may extend along and be aligned with the base segment to enable the brackets of the filter track to receive a filter having a first (e.g., greater) thickness. In a second configuration, the tab may extend crosswise to the base segment to enable the tab and one of the brackets to receive a second filter having a second (e.g., smaller) thickness. In this manner, the filter track enables the filter track system to selectively receive, retain, and capture filters having different thicknesses. Accordingly, manufacture and installation of separate filter track systems configured to receive and capture differently sized filters is avoided.

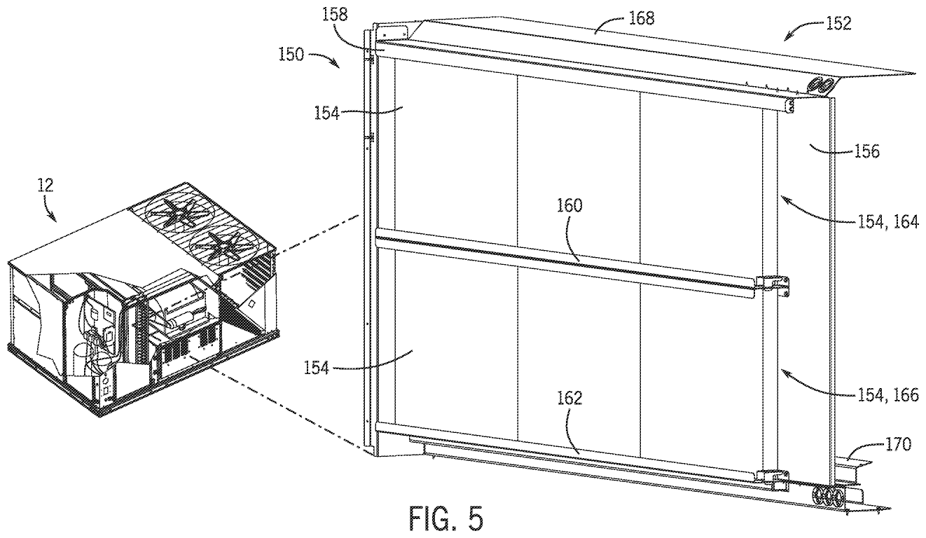

With this in mind, FIG. 5 is a front perspective view of an embodiment of a filter system 150 that may be implemented in an HVAC system to remove particles from an air flow directed through the HVAC system. For example, the filter system 150 may include the filter 38 implemented in the HVAC unit 12. Additionally or alternatively, the filter system 150 may be implemented in any suitable HVAC system, such as a split system (e.g., the residential heating and cooling system 50), a heat pump, an air handler, and so forth. In some embodiments, the filter system 150 may be configured to remove particles from a supply air flow directed to a space serviced by the HVAC system in order to improve a quality of the supply air flow for occupants within the space. In additional or alternative embodiments, the filter system 150 may be configured to remove particles from an air flow directed to cool a refrigerant or working fluid circulated within the HVAC system in order to block the particles from affecting operation of a component (e.g., a heat exchanger) of the HVAC system. In any case, the filter system 150 may improve manufacture, assembly, and operation of the HVAC system.

The filter system 150 may include a filter track system 152 (e.g., structural support system) configured to accommodate and secure (e.g., capture) one or more filters 154 within the HVAC system. The filter(s) 154 may enable flow of an air flow therethrough and may also entrap particles (e.g., particles greater than a threshold size) contained within the air flow, thereby blocking the particles from being directed downstream of the filter(s) 154. By way of example, the filter(s) 154 may include a high efficiency particulate air (HEPA) filter, a minimum efficiency reporting value (MERV) filter, an ultra-low particulate air (ULPA) filter, and/or any other suitable filter. In the illustrated embodiment, the filter track system 152 includes a frame 156 and a first end filter track assembly 158 (e.g., a top filter track assembly), an intermediate filter track assembly 160, and a second end filter track assembly 162 (e.g., a bottom filter track assembly) coupled to the frame 156. Each of the first end filter track assembly 158, the intermediate filter track assembly 160, and the second end filter track assembly 162 may be secured to the frame 156 via fasteners, welds, punches, an adhesive, or other suitable technique. In this manner, the filter track system 152 may be modular, and various components of the filter track system 152 may be separately manufactured and assembled to form the filter system 150. Additionally or alternatively, each of the first end filter track assembly 158, the intermediate filter track assembly 160, and the second end filter track assembly 162 may be integrally formed with the frame 156. For example, multiple components of the filter track system 152 may be formed in a common manufacturing process.

The first end filter track assembly 158, the intermediate filter track assembly 160, and the second end filter track assembly 162 may cooperatively capture and secure the filter(s) 154, thereby retaining a position of the filter(s) 154 within the filter system 150. For example, the filter track assemblies 158, 160, 162 may block movement of the filter(s) 154 within the filter system 150, such as from a force imparted by the air flow directed through the filter(s) 154. The first end filter track assembly 158 and the intermediate filter track assembly 160 may cooperatively capture a first set 164 (e.g., a first row, a first column, a first quantity, a first series) of the filter(s) 154, and the second end filter track assembly 162 and the intermediate filter track assembly 160 may cooperatively capture a second set 166 (e.g., a second row, a second column, a second quantity, a second series) of the filter(s) 154. Each of the first set 164 and the second set 166 includes three respective filters 154 in the illustrated filter system 150. However, additional or alternative embodiments of the filter system 150 may include any suitable number of filter(s) 154 in each of the sets 164, 166, such as one filter 154, two filters 154, and/or more than three filters 154. Indeed, the sets 164, 166 may include a different number of filters 154 relative to one another in certain implementations. Further, the filter system 150 may include any suitable number of sets of filters 154. For example, the filter system 150 may include one set (e.g., one row) of filters 154, three sets (e.g., three rows) of filters 154, and so forth.

The filter track system 152 may also include features configured to facilitate securement of the filter system 150 within the HVAC system. By way of example, the filter track system 152 may include a first mounting flange 168 (e.g., a first mounting plate) coupled to and/or extending from the frame 156. The first mounting flange 168 is configured to couple to (e.g., via fasteners) another component of the HVAC system, such as a housing or frame, to secure the filter system 150 within the HVAC system. That is, the first mounting flange 168 may maintain a desirable position of the filter system 150 within an air flow path of the HVAC system and restrict movement of the filter system 150 to facilitate removal of particles from the air flow directed through the HVAC system. The filter track system 152 may additionally or alternatively include a second mounting flange 170 (e.g., second mounting plate) that is also coupled to and/or extending from the frame 156 and is configured to facilitate securement of the filter system 150 within the HVAC system. In some embodiments, the second mounting flange 170 may also be configured to receive another component of the HVAC system and maintain a relative position between the filter system 150 and the component. As an example, the second mounting flange 170 may be configured to couple to a heat exchanger (e.g., the heat exchanger 30, a heat exchanger support), and the filter system 150 may block particles within an air flow from being directed across the heat exchanger.

The filter track system 152 may be configured to receive different embodiments of filters 154, such as filters 154 having different dimensions or sizes. By way of example, one or more of the filter track assemblies 158, 160, 162 may be adjustable to selectively retain and capture filters 154 having different thicknesses. For instance, each of the filter track assemblies 158, 160, 162 may transition between a first configuration configured to receive one embodiment of filter 154 having a first (e.g., greater) thickness and a second configuration configured to receive another embodiment of filter 154 having a second (e.g., smaller) thickness. In this manner, the filter track assemblies 158, 160, 162 may be adjusted to a desirable configuration to enable receipt of different, particularly sized filters 154 for implementation in the HVAC system.

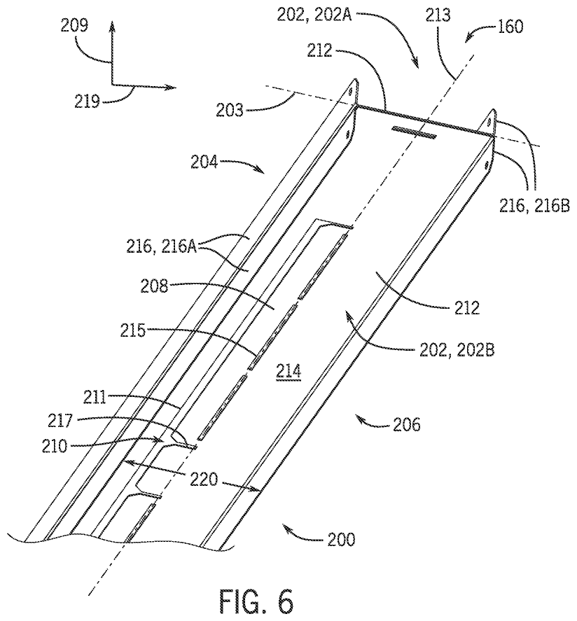

FIG. 6 is a perspective view of an embodiment of the intermediate filter track assembly 160 in a first configuration 200 and including intermediate filter tracks 204, 206. Each of the illustrated intermediate filter tracks 204, 206 may be C-shaped or U-shaped to define a respective channel 202 (e.g., guideway, passage) that may at least partially receive and capture one or more of the filters 154. Indeed, each of the intermediate filter tracks 204, 206 may have a similar shape, profile, and/or dimension. In particular, each intermediate filter track 204, 206 includes a base segment 212 and brackets 216 (e.g., a first bracket 216A and a second bracket 216B) extending crosswise from the base segment 212 (e.g., along a vertical axis 209) on opposite sides or edges of the base segment 212. The base segment 212 and the brackets 216 cooperatively define the respective channel 202 of each intermediate filter track 204, 206. The intermediate filter track assembly 160 may be generally symmetrical about a central axis 203 extending between the intermediate filter tracks 204, 206 (e.g., between the respective base segments 212 of the intermediate filter tracks 204, 206). To this end, the respective base segments 212 of the intermediate filter tracks 204, 206 may extend along one another, the respective first brackets 216A of the intermediate filter tracks 204, 206 may extend in opposite directions of one another (e.g., along the vertical axis 209), and/or the respective second brackets 216B of the intermediate filter tracks 204, 206 may extend in opposite directions of one another (e.g., along the vertical axis 209). In this manner, the intermediate filter tracks 204, 206 may be mirrored about the central axis 203.

In certain embodiments, the first intermediate filter track 204 may abut against the second intermediate filter track 206. For example, each of the first intermediate filter track 204 and the second intermediate filter track 206 may be coupled to the frame 156 to enable abutment between the intermediate filter tracks 204, 206. Additionally or alternatively, the intermediate filter track 204, 206 may be secured to one another, such as via fasteners, thereby restricting relative movement between the intermediate filter tracks 204, 206. In further embodiments, the intermediate filter track assembly 160 may include a single intermediate filter track instead of separate intermediate filter tracks 204, 206. That is, the single intermediate filter track may include the profiles and/or geometries of both the intermediate filter track 204, 206 in the illustrated embodiment to enable accommodation and securement of different filters 154. These aforementioned embodiments may reduce a physical footprint (e.g., an overall height) occupied by the filter track system 152 and the filter system 150 as compared to embodiments in which the intermediate filter tracks 204, 206 are offset from one another (e.g., to form a space between the intermediate filter tracks 204, 206).

In some embodiments, the first intermediate filter track 204 may be configured to receive one or more of the filters 154 of the first set 164, and the second intermediate filter track 206 may be configured to receive one or more of the filters 154 of the second set 166. For example, the base segments 212 of the first intermediate filter track 204 and the second intermediate filter track 206 may be coupled to and/or may abut one another, such that a first channel 202A of the first intermediate filter track 204 is configured to accommodate and support one or more of the filters 154 of the first set 164 and a second channel 202B of the second intermediate filter track 206 accommodate and support one or more of the filters 154 of the second set 166 (e.g., beneath the first set 164 with respect to gravity).

Moreover, the second intermediate filter track 206 may include one or more tabs, lips, flaps, or flanges 208 formed therein. As an example, the second intermediate filter track 206 may include cuts (e.g., openings, punctures, slits, slots) 210 formed in the base segment 212 to define and provide the tabs 208. In other words, the tabs 208 may be integrally formed in the second intermediate filter track 206. Thus, the second intermediate filter track 206 may include a single piece component that includes the base segment 212, the brackets 216, and the tab 208. The tabs 208 may be adjustable relative to a remainder of the base segment 212 of the second intermediate filter track 206 to transition the second intermediate filter track 206 between the first configuration 200 and a second configuration further described below. For example, the tabs 208 may rotate, bend, pivot, or fold about the base segment 212, such as about a rotational axis 213 extending along the second channel 202B of the second intermediate filter track 206. To this end, the cuts 210 may include one or more first cuts 211 formed along the rotational axis 213 and one or more second cuts 217 formed crosswise to the rotational axis 213 in order to define the tab 208 configured to rotate about the rotational axis 213. In certain embodiments, the rotational axis 213 may be centrally located between the brackets 216 extending crosswise from opposite sides of the base segment 212. Alternatively, the rotational axis 213 may not be centered between the brackets 216 and may be positioned closer to one of the brackets 216. In some embodiments, the cuts 210 may include one or more intermediate cuts 215 formed through the base segment 212 along the rotational axis 213. The intermediate cuts 215 may enable application of a reduced force (e.g., a manual force applied by a user) to drive rotation of the tabs 208 about the rotational axis 213, thereby facilitating rotation of the tabs 208 about the base segment 212. As such, the intermediate cuts 215 may facilitate ease of transitioning the second intermediate filter track 206 between the first configuration 200 and a second configuration.

In the first configuration 200, the tabs 208 may extend along or be aligned with (e.g., parallel to, flush with) the base segment 212 of the second intermediate filter track 206. Thus, in the first configuration 200, the second intermediate filter track 206 may be configured to accommodate a first embodiment of the filter 154 in a first passage or space 214 of the second channel 202B. The first passage 214 may be substantially similar or the same in size and/or dimension as the second channel 202B. That is, the first passage 214 may extend a first distance 220 along a horizontal axis 219 (e.g., a lateral axis, an axis oriented perpendicularly to the rotational axis 213) from the first bracket 212A to the second bracket 212B of the second intermediate filter track 206. Accordingly, the first passage 214 may accommodate a first embodiment of the filter 154 having a thickness (e.g., a greater thickness) that generally extends from the first bracket 216A to the second bracket 216B of the second intermediate filter track 206 (e.g., substantially a full dimension of the first distance 220). With the first embodiment of the filter 154 disposed within the first passage 214, each of the tabs 208 and the base segment 212 may abut or engage a common side of the filter 154 (e.g., top side or surface of the filter 154), and the brackets 216 may abut or engage opposite sides (e.g., vertical sides or surfaces) of the filter 154, thereby retaining the filter 154 in the second intermediate filter track 206.

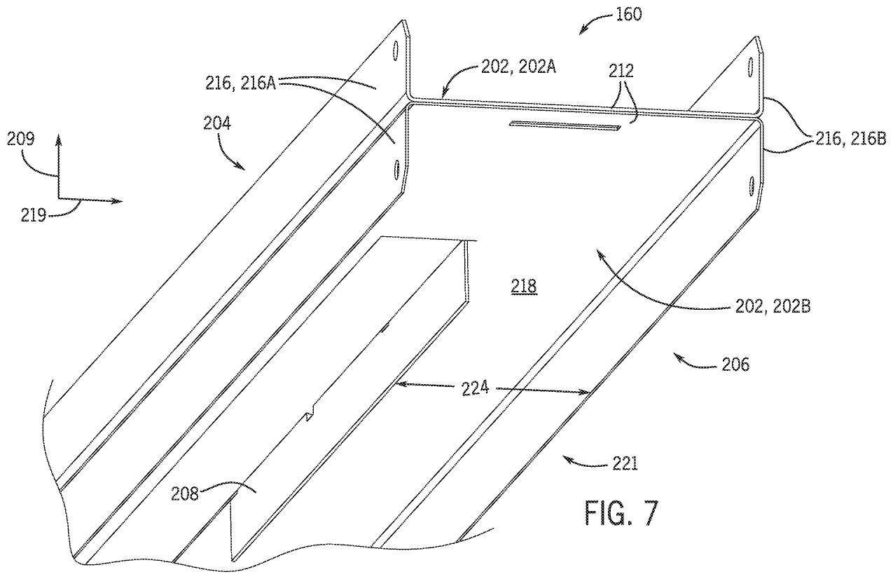

FIG. 7 is a perspective view of an embodiment of the intermediate filter track assembly 160 in a second configuration 221. To transition the second intermediate filter track 206 to the second configuration 221, the tabs 208 may be rotated about the rotational axis 213 to extend crosswise to the base segment 212, such as substantially parallel or in a common direction with the brackets 216 (e.g., along the vertical axis 209). In this manner, the tabs 208, the base segment 212, and the second bracket 216B of the second intermediate filter track 206 may cooperatively define a second passage or space 218 of the second intermediate filter track 206 in the second configuration 221. As shown, the second passage 218 occupies a portion of the second channel 202B of the second intermediate filter track 206 and extends a second distance 224 from the tab 208 to the second bracket 216B of the second intermediate filter track 206. In the second configuration 221, the second intermediate filter track 206 is configured to receive and secure a second embodiment of the filter 154 within the second passage 218. Specifically, the second embodiment of the filter 154 may have a thickness (e.g., a smaller thickness) that extends from the tab 208 to the second bracket 216B of the second intermediate filter track 206 (e.g., substantially a full dimension of the second distance 224). With the second embodiment of the filter 154 disposed within the second passage 218, the base segment 212 may abut or engage a side (e.g., a top side or surface) of the filter 154, and the tab 208 and the second bracket 216B of the second intermediate filter track 206 may abut or engage opposite sides (e.g., vertical sides) of the filter 154, thereby retaining the filter within the second intermediate filter track 206.

As noted above, the cuts 210 may be formed directly into the second intermediate filter track 206. Thus, the second intermediate filter track 206 is configured to accommodate and secure differently sized filters 154 without usage of a separate component dedicated to capturing differently sized filters 154. For example, the tabs 208 of the second intermediate filter track 206 may enable the second intermediate filter track 206 to selectively retain and capture filters 154 having different thicknesses without usage of an additional component, such as a filter track insert, that may be coupled to or otherwise assembled with the second intermediate filter track 206. As such, present embodiments may reduce costs associated with manufacture, maintenance, configuration, replacement, and/or assembly of the filter system 150 and/or the HVAC system. For example, present embodiments mitigate costs associated with manufacture of additional component implemented to enable accommodation and securement of differently sized filters and/or avoid procedural steps associated with assembly or disassembly of additional components during a filter change process. Furthermore, in certain embodiments, the tabs 208 may be manually adjustable (e.g., bent) to transition the second intermediate filter track 206 between the first configuration 200 and the second configuration 221. Thus, the second intermediate filter track 206 may be more readily adjusted and configured to receive differently sized filters 154, such as without the use of certain additional tools or devices. Moreover, the second intermediate filter track 206 may be formed from a malleable material, such as sheet metal, to enable manual adjustment of the tabs 208, as well as to retain the second intermediate filter track 206 in the first configuration 200 or the second configuration 221. That is, the material may be resilient and may resist unintentional movement of the tabs 208 via a force (e.g., imparted by the filter 154, imparted by an air flow) below a threshold level, yet the material may elastically deform to enable transition of the second intermediate filter track 206 between the first configuration 200 and the second configuration 221.

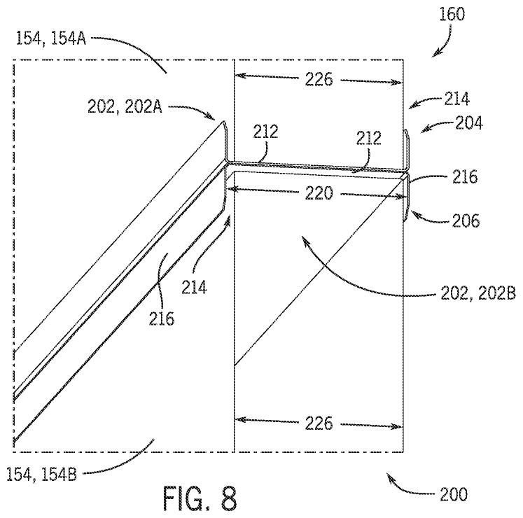

FIG. 8 is a perspective view of an embodiment of the second intermediate filter track 206 in the first configuration 200 in which the tabs 208 extend along and/or are aligned with the base segment 212. The intermediate filter track assembly 160 is illustrated as supporting (e.g., retaining) a first filter 154A and a second filter 154B. In the illustrated embodiment, the first intermediate filter track 204 receives and supports the first filter 154A (e.g., within the first passage 214 of first channel 202A), and the second intermediate filter track 206 receives and supports the second filter 154B (e.g., within the first passage 214 of the second channel 202B). As an example, each of the base segment 212 and the brackets 216 of the first intermediate filter track 204 may engage with the first filter 154A, and each of the base segment 212 and the brackets 216 of the second intermediate filter track 206 may engage with the second filter 154B. The first filter 154A and the second filter 154B may have approximately the same first thickness 226, which may span the first distance 220 between the respective brackets 216A, 216B of the intermediate filter tracks 204, 206. Indeed, the first filter 154A and the second filter 154B may be of the same embodiment. For example, the first thickness 226 may be relatively large, such as 10 centimeters (approximately 4 inches), 15 centimeters (approximately 6 inches), 20 centimeters (approximately 8 inches), more than 20 centimeters, and so forth.

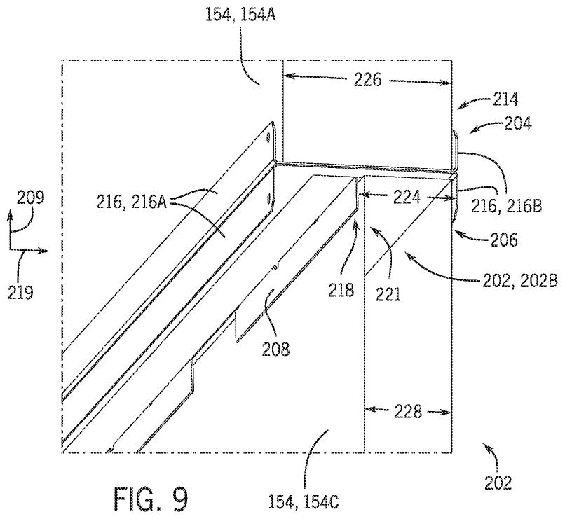

FIG. 9 is a perspective view of an embodiment of the second intermediate filter track 206 in the second configuration 221 in which the tabs 208 extend in a common direction with the brackets 216 (e.g., along the vertical axis 209). That is, the tabs 208 extend crosswise to the base segment 212 of the second intermediate filter track 206 in the second configuration 221. In the second configuration 221, the second intermediate filter track 206 may be configured to receive and support (e.g., retain) a third filter 154C within the second passage 218 of the second channel 202B of the second intermediate filter track 206. The third filter 154C may be of a different embodiment than the first filter 154A and/or the second filter 154B and may have a second thickness 228 that is less than the first thickness 226 of the first filter 154A and/or of the second filter 154B. For instance, the second thickness 228 of the third filter 154 may be 5 centimeters (approximately 2 inches), 2.5 centimeters (approximately 1 inch), less than 2.5 centimeters, and so forth. Thus, the intermediate filter track assembly 160 may be adjusted receive, support, and capture multiple different embodiments of filters 154. The second thickness 228 of the third filter 154C may span the second distance 224 between the tabs 208 and the second bracket 216B of the second intermediate filter track 206 instead of the first distance 220 between both of the brackets 216 of the second intermediate filter track 206. Accordingly, the tabs 208, the second base segment 212, and the second bracket 216B of the second intermediate filter track 206 may engage with the third filter 154C. Thus, the second intermediate filter track 206 may be adjusted to selectively receive and retain filters 154 having different thicknesses (e.g., the thicknesses 226, 228).

By way of example, the HVAC system may initially be installed to utilize filters 154 having a first, greater thickness (e.g., the first thickness 226). To this end, the second intermediate filter track 206 may initially be implemented in the first configuration 200. However, after installation, the HVAC system may be adjusted to utilize filters 154 having a second, smaller thickness (e.g., the second thickness 228). Accordingly, the second intermediate filter track 206 may be adjusted to the second configuration 221. As such, the second intermediate filter track 206 may enable the HVAC system to be readily adjusted to selectively retain filters 154 having different thicknesses. Indeed, the second intermediate filter track 206 may be adjusted between the first configuration 200 and the second configuration 221 as desired after manufacture and installation of the second intermediate filter track 206 to support filters 154 having different thicknesses. Accordingly, the second intermediate filter track 206 may increase design and/or operational flexibility of the filter system 150. Further, manufacture of separate (e.g., different) filter systems to accommodate and support different embodiments of filters 154 may be avoided.

As further described herein, the first intermediate filter track 204 may also be configured and/or adjustable to receive and support differently-sized filters 154. In some instances, each of the first intermediate filter track 204 and the second intermediate filter track 206 may be configured (e.g., adjusted) to receive and support filters 154 having the same thicknesses (e.g., the first thickness 226, the second thickness 228). That is, each of the filters 154 of the first set 164 and the second set 166 may have the same thickness. Additionally or alternatively, each of the first intermediate filter track 204 and the second intermediate filter track 206 may be configured (e.g., adjusted) to receive and support filters 154 having different thicknesses in some instances. In other words, the filters 154 of the first set 164 may have a different thickness than that of the filters 154 of the second set 166.

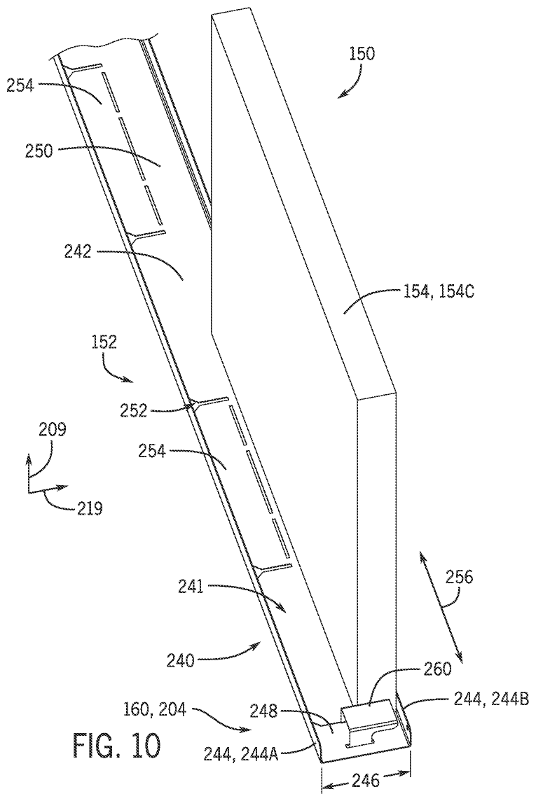

FIG. 10 is a top perspective view of an embodiment of a portion of the filter system 150. The illustrated embodiment includes a primary filter track 240 configured to couple to the frame 156 and an auxiliary filter track 242 configured to engage with the primary filter track 240 in an assembled configuration. The primary filter track 240 may include brackets 244 extending crosswise from a base segment 248 (e.g., along the vertical axis 209) at opposite sides or edges of the base segment 248 to define a channel 241 of the primary filter track 240. The auxiliary filter track 242 may be positioned within the channel 241 and may engage with (e.g., abut) the base segment 248. As shown, the primary filter track 240 and the auxiliary filter track 242 are configured to support one or more filters 154 positioned above the primary filter track 240 and the auxiliary filter track 242 (e.g., relative to the vertical axis 209). Accordingly, the primary filter track 240 and the auxiliary filter track 242 may be utilized as components of one or more of the filter track assemblies discussed above, such as the intermediate filter track assembly 160 and/or the second end filter track assembly 162.

The primary filter track 240 and the auxiliary filter track 242 may cooperatively secure one or more filters 154 (e.g., the first filter 154A, the second filter 154B, the third filter 154C) in a desired, installed position. In some embodiments, the filter 154 may be positioned within the channel 241 of the primary filter track 240, and the auxiliary filter track 242 may engage with the filter 154 positioned within the channel 241. As an example, for filters 154 (e.g., the first filter 154A, the second filter 154B) having the first thickness 226, a first bracket 244A and a second bracket 244B of the primary filter track 240 may capture opposite sides of the filter 154. For instance, a third distance 246 spanning between the brackets 244 of the primary filter track 240 may be approximately equal to the first distance 220 between the brackets 216 of the second intermediate filter track 206. Thus, the primary filter track 240 may accommodate and secure the filter 154 having the first thickness 226 between the brackets 244. Furthermore, the filter 154 positioned within the channel 241 may engage with and/or abut a base segment 250 of the auxiliary filter track 242. In this manner, the brackets 244 of the primary filter track 240 and the base segment 250 of the auxiliary filter track 242 may cooperatively capture an embodiment of the filter 154 having the first thickness 226.

Furthermore, cuts or openings 252 may be formed through the auxiliary filter track 242 (e.g., through the base segment 250) to form tabs 254 that are adjustable to change a configuration of the auxiliary filter track 242 to enable capture of an embodiment of the filter 154 having the second thickness 228. In some embodiments, the tabs 254 may be rotated, bent, pivoted, or folded relative to a remainder of the base segment 250. For instance, in a first configuration, such as the configuration shown in FIG. 10, the tabs 254 may extend along or be aligned with (e.g., parallel to, flush with) the base segment 250 of the auxiliary filter track 242. In the first configuration, the tabs 254 may engage with and/or abut the base segment 248 of the primary filter track 240 and enable the primary filter track 240 to accommodate filters 154 having the first thickness 226 (e.g., extending between the brackets 244 of the primary filter track 240). In a second configuration, the tabs 254 may extend crosswise relative to the base segment 250 and the base segment 248, such as along the brackets 244 (e.g., along the vertical axis 209). In this second configuration, the primary filter track 240 and the auxiliary filter track 242 may be configured to accommodate filters 154 having the second thickness 228. As an example, the tabs 254 extending along the vertical axis 209, the base segment 250 of the auxiliary filter track 242, and the second bracket 244B of the primary filter track 240 may cooperatively capture filters 154 having the second thickness 228. Accordingly, the tabs 254 may be adjusted as desired to configure the filter system 150 for use with differently sized filters 154.

In certain embodiments, the auxiliary filter track 242 may facilitate installation and/or removal of the filter 154 with respect to filter system 150. For example, the auxiliary filter track 242 may be manually movable relative to the primary filter track 240. To this end, the auxiliary filter track 242 may not be fixedly coupled, secured, or fastened to the primary filter track 240 in order to enable translation of the auxiliary filter track 242 within the channel 241 and along the primary filter track 240 (e.g., along the base segment 248) in directions 256 (e.g., longitudinal directions). For instance, the brackets 244 of the primary filter track 240 may engage with or capture the auxiliary filter track 242 to block certain movement of the auxiliary filter track 242, such as along the horizontal axis 219, relative to the primary filter track 240 and enable movement of the auxiliary filter track 242 along the directions 256 relative to the primary filter track 240. A force may be applied to the auxiliary filter track 242 to translate the auxiliary filter track 242 along the directions 256 to insert the auxiliary filter track 242 into the channel 241 and/or remove the auxiliary filter track 242 from the channel 241 (e.g., from between the brackets 244). In some embodiments, the auxiliary filter track 242 may include a handle or grip 260, which may be attached to or integral with the base segment 250 of the auxiliary filter track 242. The handle 260 may facilitate manual movement and positioning of the auxiliary filter track 242 within the channel 241. For example, a user (e.g., a technician, an operator) may grasp the handle 260 to impart a force that drives movement of the auxiliary filter track 242 within the channel 241, such as along the directions 256.

Additionally, the filters 154 may remain captured by the auxiliary filter track 242 (e.g., the base segment 250, the tabs 254) during movement of the auxiliary filter track 242 relative to the primary filter track 240 to enable corresponding movement of the filter(s) 154 relative to the primary filter track 240. As an example, multiple filters 154 may be positioned onto the auxiliary filter track 242, and the auxiliary filter track 242 may be inserted into the channel 241 of the primary filter track 240 to concurrently insert each of the filters 154 into the primary filter track 240 and install the filters 154 within the filter system 150. As another example, the auxiliary filter track 242 and may be removed from the channel 241 to concurrently remove multiple filters 154 from the primary filter track 240. Thus, the assembly of the primary filter track 240 and the auxiliary filter track 242 may facilitate ease of installation and/or removal of filters 154 with respect to the filter system 150. However, in additional or alternative embodiments, the auxiliary filter track 242 may not be utilized. For example, the cuts 252 may be formed directly through the primary filter track 240 (e.g., the base segment 248) such that the tabs 254 are integral to the primary filter track 240 (e.g., the base segment 248) and are adjustable (e.g., rotatable about a remainder of the base segment 248) to enable accommodation and securement of filters 154 having the different thicknesses 226, 228.

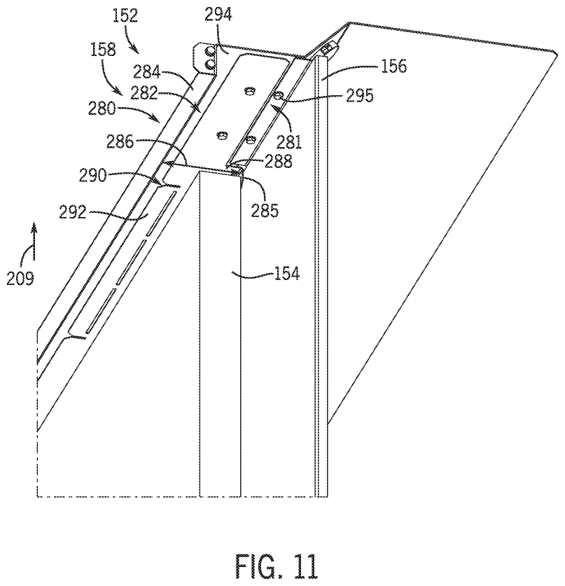

FIG. 11 is a bottom perspective view of an embodiment of the first end filter track assembly 158 of the filter system 150. The first end filter track assembly 158 may include a primary filter track 280 configured to couple to the frame 156 (e.g., via a fastener) and an auxiliary filter track 282 configured to engage with the primary filter track 280 in an assembled configuration of the first end filter track assembly 158. The primary filter track 280 may be configured to capture embodiments of the filter 154 (e.g., the first filter 154A, the second filter 154B) having the first thickness 226. For example, the primary filter track 280 may include a first bracket 284 and a second bracket 285 extending crosswise from a base segment 294 (e.g., along the vertical axis 209) of the primary filter track 280 to define a channel 281 of the primary filter track 280. One or more filters 154 may be inserted into the channel 281, and the brackets 284, 285 may capture opposite sides of the filter 154. For example, the brackets 284, 285 may be offset from one another by a fourth distance 286, which may be approximately equal to the first distance 220 between the brackets 216 and/or the third distance 246 between the brackets 244 to accommodate filters 154 having the first thickness 226. The auxiliary filter track 282 may be inserted within the channel 281 between the brackets 284, 285. For instance, the auxiliary filter track 282 may be coupled to the base segment 294 of the primary filter track 280, such as via fasteners 295 (e.g., screws, rivets). A base segment 288 of the auxiliary filter track 282 may engage with the filter 154 inserted within the channel 281. In this manner, the brackets 284, 285 and the base segment 288 may cooperatively capture filters 154 having the first thickness 226.

Cuts or openings 290 may be formed through the auxiliary filter track 282 (e.g., into the base segment 288) to form tabs 292 to enable capture of filters 154 having the second thickness 228. For example, the tabs 292 may be rotated, bent, pivoted, or folded about a remainder of the base segment 288, as desired, to enable capture of embodiments of the filter 154 having different thicknesses 226, 228. Indeed, the tabs 292 may extend along or be aligned with (e.g., parallel to, flush with) the base segment 288 of the auxiliary filter track 282 to enable securement of filters 154 having the first thickness 226 (e.g., between the brackets 284, 285). Additionally, the tabs 292 may be adjusted to extend crosswise (e.g., along the vertical axis 209) relative to the base segment 288 to enable capture of filters 154 having the second thickness 228 between the tabs 292 and the second bracket 285. As an example, the tabs 292, the base segment 288 of the primary filter track 280, and the second bracket 285 may engage with the filter 154 having the second thickness 228. In this way, the second bracket 285, the base segment 288, and the tabs 292 may cooperatively capture filters 154 having the smaller thickness 228. As such, the tabs 292 may be adjusted to accommodate various thicknesses of the filter 154 to be captured by the filter track system 152.

In certain embodiments, the auxiliary filter track 282 may be fixedly secured to the primary filter track 280, such as to the base segment 294 of the primary filter track 280, to increase structural rigidity of the filter track system 152. Rigid coupling between the primary filter track 280 and the auxiliary filter track 282 may block deformation, distortion, and/or displacement of the first end filter track assembly 158 in response to a force imparted onto the first end filter track assembly 158, such as an object placed atop the filter system 150. In additional or alternative embodiments of the first end filter track assembly 158, the cuts 290 may be formed directly into the primary filter track 280, such that the tabs 292 are integral to the primary filter track 280. In such embodiments, the first end filter track assembly 158 may not include the auxiliary filter track 282.

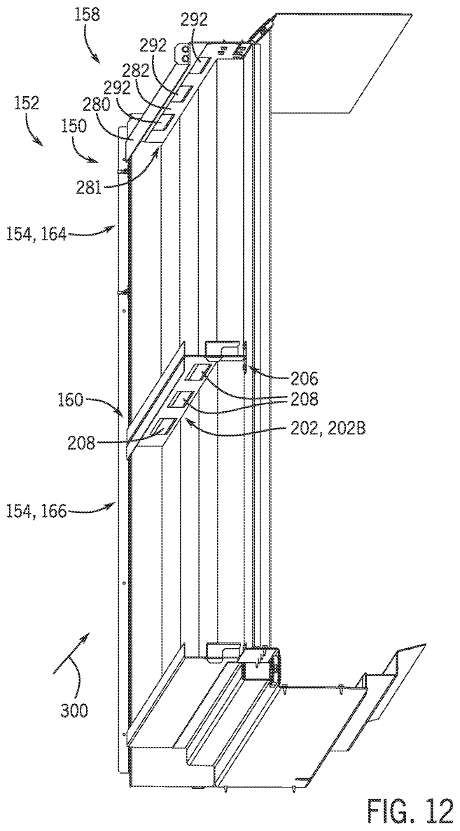

FIG. 12 is a side perspective view of an embodiment of the filter system 150 in an assembled configuration of the filter track system 152 in which the filters 154 are inserted into the channel 281 of the primary filter track 280 and the second channel 202B of the second intermediate filter track 206. In the assembled configuration, each of the tabs 208 of the second intermediate filter track 206 of the intermediate filter track assembly 160 may align with a respective one of the filters 154 of the second set 166, and each of the tabs 292 of the auxiliary filter track 282 of the first end filter track assembly 158 may align with a respective one of the filters 154 of the first set 164. In other words, each tab 208 of the second intermediate filter track 206 may overlap with a single filter 154 of the second set 166 along a horizontal axis 300 (e.g., a longitudinal axis), and each tab 292 of the auxiliary filter track 282 may overlap with a single filter 154 of the first set 164. Thus, upon adjustment (e.g., rotation, bending, pivoting, folding) to extend along the vertical axis 209, the tabs 208, 292 may help secure an individual one of the filters 154. To this end, the number of tabs 208, 292 may match, correspond to, or be associated with the number of filters 154 to be retained within the first end filter track assembly 158, the intermediate filter track assembly, and the second end filter track assembly 162. In additional or alternative embodiments, the filter system 150 may include different number of tabs 208, 292 than filters 154. As an example, a single one of the tabs 208, 292 may overlap with multiple filters 154 (e.g., the filter system 150 may have a greater quantity of filters 154 than tabs 208, 292), and/or each filter 154 may align with or overlap with multiple tabs 208, 292 (e.g., the filter system 150 may have a greater quantity of tabs 208, 292 than filters 154). Thus, one of the tabs 208, 292 extending along the vertical axis 209 may help secure more than one of the filters 154.

In the illustrated embodiment, each of the filters 154 of the first set 164 and the second set 166 has approximately the same thickness (e.g., the second thickness 228). However, in additional or alternative embodiments, filters 154 within any of the first set 164 and/or the second set 166 may have differently sized thicknesses. In other words, the first set 164 may include filters 154 having differently sized thicknesses, and/or the second set 166 may include filters 154 having differently sized thicknesses. To this end, each tab 208 of the second intermediate filter track 206 and each tab 292 of the auxiliary filter track 282 may be independently adjustable. By way of example, in a third configuration of the second intermediate filter track 206, one of the tabs 208 of the second intermediate filter track 206 may be oriented to enable securement of a corresponding filter 154 having the first thickness 226 within the second intermediate filter track 206, and another one of the tabs 208 may be oriented to enable securement of a corresponding filter 154 having the second thickness 228 within the second intermediate filter track 206. Thus, the second intermediate filter track 206 may concurrently retain filters 154 having different thicknesses 226, 228. Similarly, one of the tabs 292 of the first end filter track assembly 158 may be oriented to enable securement of a corresponding filter 154 having the first thickness 226 within the primary filter track 280, and another one of the tabs 292 may be oriented to enable securement of a corresponding filter 154 having the second thickness 228 within the first end filter track assembly 158. As such, the first end filter track assembly 158 may also concurrently retain filters 154 having different thicknesses 226, 228.

Further, although each of the first end filter track assembly 158, the intermediate filter track assembly 160, and the second end filter track assembly 162 is described above as being adjustable to accommodate and secure filters 154 having two different thicknesses 226, 228, in additional or alternative embodiments, the first end filter track assembly 158, the intermediate filter track assembly 160, and/or the second end filter track assembly 162 may be adjustable to accommodate and secure filters 154 more than two different additional thicknesses. For example, any of the filter track assemblies 158, 160, 162 described herein may be adjustable between two, three, four, or more different to enable securement of numerous different embodiments of filters 154 having a variety of different thicknesses. For example, the disclosed tabs may be configured to adjust between additional positions (e.g., three or more positions), and/or additional tabs may be formed (e.g., via additional cuts and/or openings) to enable securement of other embodiments of the filters 154.

It should also be noted that existing HVAC systems may be retrofit with any of the components described herein and/or to include any of the features described herein. For example, the disclosed filter system 150, such as any of the filter track assemblies 158, 160, 162, may be implemented in an existing HVAC system to enable implementation of differently sized filters 154 into the HVAC system. As such, existing HVAC systems may realize the benefit provided by the filter system 150 and the presently disclosed techniques.

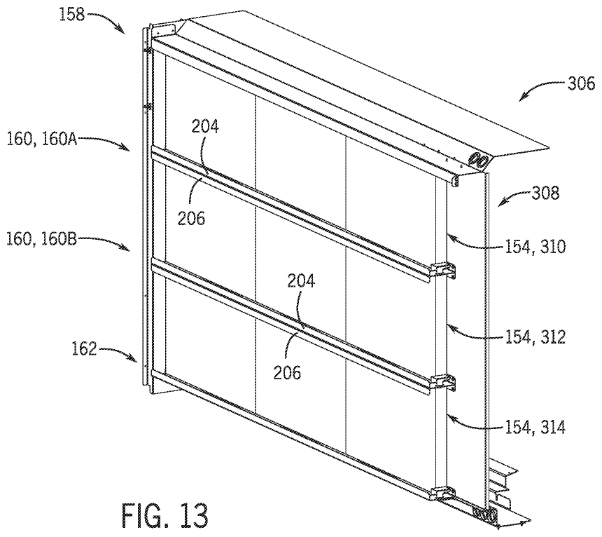

FIG. 13 is a front perspective view of an embodiment of a filter system 306 including a filter track system 308. The filter track system 308 may be configured to receive three sets of filters 154. To this end, the illustrated filter track system 308 includes the first end filter track assembly 158, a first intermediate filter track assembly 160A, a second intermediate filter track assembly 160B, and the second end filter track assembly 162. The first end filter track assembly 158 and the first intermediate filter track assembly 160A may cooperatively capture a first set 310 of the filters 154, the first intermediate filter track assembly 160A and the second intermediate filter track assembly 160B may cooperatively capture a second set 312 of the filters 154, and the second intermediate filter track assembly 160B and the second end filter track assembly 162 may cooperatively capture a third set 314 of the filters 154.

Additionally, each of the first end filter track assembly 158, the first intermediate filter track assembly 160A, the second intermediate filter track assembly 160B, and the second end filter track assembly 162 may be adjustable to capture filters 154 having different dimensions (e.g., thicknesses). For example, the first end filter track assembly 158 may include the primary filter track 280 and the auxiliary filter track 282, which may further include the tabs 292 that are adjustable to enable capture of differently sized filters 154 via the first end filter track assembly 158. The second end filter track assembly 162 may include the primary filter track 240 and the auxiliary filter track 242, which may include the tabs 254 that are adjustable to enable capture of differently sized filters 154 via the second end filter track assembly 162. Additionally, each of the first intermediate filter track assemblies 160 may include the first intermediate filter track 204 and the second intermediate filter track 206. In some embodiments, each first intermediate filter track 204 may include the primary filter track 240 and the auxiliary filter track 242 having the tabs 254 that are adjustable to enable capture of differently sized filters 154 via the first intermediate filter track 204. Furthermore, each second intermediate filter track 206 may include the tabs 208 that are adjustable to enable capture of differently sized filters 154 via the second intermediate filter track 206. As such, the filter system 306 may be adjustable to accommodate sets 310, 312, 314 of filters 154 that may include differently sized filters 154. Although the illustrated filter system 306 is configured to accommodate three sets 310, 312, 314 of filters 154, additional or alternative embodiments of the filter system 306 may be configured to accommodate more than three sets of filters 154, such as via additional intermediate filter track assemblies 160.

The present disclosure may provide one or more technical effects useful in the operation of an HVAC system. For example, the HVAC system may include a filter system configured to receive, capture, and/or secure differently sized filters, such as filters having different thicknesses. The filter system may include a filter track that is adjustable to capture and retain a particularly sized filter or a filter having a particular thickness. In some embodiments, the filter track may include a base segment and brackets extending crosswise to the base segment. Additionally, cuts may be formed through the base segment to form a tab between the brackets. In a first configuration of the filter track, the tab may be oriented to enable the brackets to capture a filter having a greater thickness. In a second configuration of the filter track, the tab may be adjusted to enable the tab and one of the brackets to capture a filter having a smaller thickness. In this manner, the tab may be manipulated to adjust the filter track between the first configuration and the second configuration to receive and secure filters of different thicknesses. As a result, a single embodiment of the filter system may be configured (e.g., adjustable) to secure multiple embodiments of filters, thereby reducing costs associated with manufacture of different HVAC systems, increasing design and/or operational flexibility associated with HVAC systems, and/or improving ease of modification of HVAC systems with respect to utilizing different filters. For example, manufacture of a particular embodiment of a filter system that may accommodate filters having a specific size but may not accommodate filters having a different size may be avoided. The technical effects and technical problems in the specification are examples and are not limiting. It should be noted that the embodiments described in the specification may have other technical effects and can solve other technical problems.

While only certain features and embodiments of the disclosure have been illustrated and described, many modifications and changes may occur to those skilled in the art, such as variations in sizes, dimensions, structures, shapes and proportions of the various elements, values of parameters, including temperatures and pressures, mounting arrangements, use of materials, colors, orientations, and so forth without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described, such as those unrelated to the presently contemplated best mode of carrying out the disclosure, or those unrelated to enabling the claimed disclosure. It should be noted that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A filter track system of a heating, ventilation, and/or air conditioning (HVAC) system, comprising:
a filter track comprising a base segment, a first bracket extending crosswise to the base segment, a second bracket extending crosswise to the base segment, and a tab formed in the base segment, wherein the filter track is configured to capture a first filter via the first bracket and the second bracket in a first configuration of the filter track, and the filter track is configured to capture a second filter via the tab and the first bracket in a second configuration of the filter track.

2. The filter track system of claim 1, wherein the base segment comprises a plurality of cuts formed therethrough to form the tab in the base segment.

3. The filter track system of claim 1, wherein the tab is aligned with the base segment in the first configuration of the filter track, and the tab extends crosswise to the base segment in the second configuration of the filter track.

4. The filter track system of claim 3, wherein the tab is rotatable relative to the base segment to adjust the filter track between the first configuration and the second configuration.

5. The filter track system of claim 1, wherein the tab is a first tab, the filter track comprises a second tab formed in the base segment, and the filter track is configured to capture a third filter via the second tab and the first bracket in the second configuration of the filter track.

6. The filter track system of claim 1, comprising the first filter and the second filter, wherein the first filter comprises a first thickness greater than a second thickness of the second filter.

7. The filter track system of claim 1, wherein the filter track is a single piece component comprising the base segment, the first bracket, the second bracket, and the tab.

8. A filter system of a heating, ventilation, and/or air conditioning (HVAC) system, comprising:
a filter track comprising a base segment, a first bracket and a second bracket extending from opposite sides of the base segment, and a tab integral with the base segment and formed between the first bracket and the second bracket, wherein the tab is configured to extend along the base segment in a first configuration of the filter track, and the tab is configured to extend crosswise to the base segment in a second configuration of the filter track,
wherein the filter track is configured to capture a first filter in the first configuration of the filter system, and the filter track is configured to capture a second filter in the second configuration of the filter system.

9. The filter system of claim 8, wherein the tab and the first bracket of the filter track are configured to capture the second filter in the second configuration of the filter track.

10. The filter system of claim 9, wherein the base segment, the first bracket, and the second bracket define a channel of the filter track, and the base segment, the tab, the first bracket define a passage within the channel in the second configuration, and the filter track is configured to retain the second filter in the passage in the second configuration.

11. The filter system of claim 8, wherein the first bracket and the second bracket are configured to capture the first filter in the first configuration of the filter track.

12. The filter system of claim 8, wherein the filter track is formed from sheet metal.

13. The filter system of claim 8, wherein the tab is configured to rotate about a rotational axis to transition the filter track between the first configuration and the second configuration, and the base segment comprises a cut formed along the rotational axis.

14. The filter system of claim 8, wherein the tab and the base segment are configured to abut a common side of the first filter in the first configuration of the filter track.

15. A filter system of a heating, ventilation, and/or air conditioning (HVAC) system, comprising:
a filter track comprising a base segment, a first bracket extending crosswise to the base segment, and a second bracket extending crosswise to the base segment, wherein the base segment comprises a plurality of openings formed therethrough to form a tab in the base segment between the first bracket and the second bracket, and the tab is adjustable to selectively retain a first filter and a second filter within the filter track,
wherein the tab and the base segment are configured to engage with a common side of the first filter to retain the first filter within the filter track, and the tab and the first bracket are configured to engage with opposite sides of the second filter to retain the second filter within the filter track.

16. The filter system of claim 15, wherein the tab extends along the base segment to retain the first filter within the filter track, and the tab extends crosswise to the base segment to retain the second filter within the filter track.

17. The filter system of claim 16, wherein the tab is rotatable about a rotational axis to transition between a first configuration extending along the base segment and a second configuration extending crosswise to the base segment.

18. The filter system of claim 15, wherein the filter track is a first filter track, the base segment is a first base segment, and the filter system comprises a second filter track comprising a second base segment, a third bracket extending crosswise to the second base segment, and a fourth bracket extending crosswise to the second base segment, the second filter track is configured to capture a third filter, and the first base segment abuts the second base segment.

19. The filter system of claim 18, wherein the first bracket and the second bracket of the first filter track extend in opposite directions relative to the third bracket and the fourth bracket of the second filter track.

20. The filter system of claim 15, wherein the first bracket and the second bracket are configured to engage opposite sides of the first filter.
